(19) United States
(12) Patent Application Publication
(10) Pub. No.: US 2026/0065513 A1
(43) Pub. Date: Mar. 5, 2026

(54) METHODS AND APPARATUSES FOR ENCODING AND DECODING A POINT CLOUD

(71) Applicant: InterDigital CE Patent Holdings, SAS, Paris (FR)

(72) Inventors: Rodrigo Borba Pinheiro, Rennes (FR); Jean-Eudes Marvie, Plerin (FR); Neus Sabater, Betton (FR)

(21) Appl. No.: 19/109,445

(22) PCT Filed: Aug. 24, 2023
(86) PCT No.: PCT/EP2023/073299

§ 371 Date: Mar. 6, 2025

(30) Foreign Application Priority Data
Sep. 6, 2022 (EP) 22306317.3

(51) Int. Cl. G06T 9/00

(52) U.S. Cl. CPC G06T 9/002

(57) ABSTRACT

A method and an apparatus for coding one or more attributes of a point cloud are provided, wherein the one or more attributes are coded using a normalizing flow architecture comprising an invertible neural network and one or more 3D sparse convolutions. In some variants, the invertible neural network comprises a voxel shuffling layer, a sparse 1×1 convolution layer and one or more coupling layers that use 3D sparse convolutions. The voxel shuffling layer allows for trading the spatial size of the input to a number of channels, by rearranging spatial location of voxels into channel locations. In a variant, the voxel shuffling layer is designed for 3D sparse data by filling empty voxels at the channel locations.

This application claims the priority to European Patent Application No. 22306317.3, filed on 6 Sep. 2022, which is incorporated herein by reference in its entirety.

### TECHNICAL FIELD

The present embodiments generally relate to point cloud compression. More particularly, the present embodiments relate to a method and an apparatus for coding a point cloud using a normalizing flow-based architecture.

### BACKGROUND

The use of 3D applications is becoming more popular every day, and to be able to exploit said applications different data formats are being used. One of the main data formats is point cloud representation. Point clouds are a set of unordered points having coordinates x, y, z, corresponding to the location of a point in the space (also known as geometry of the point cloud) and having attributes (colors, normal vectors, etc.).

The use of this type of data requires the creation of new compression methods to efficiently store and transmit data, especially since point clouds can have millions of points.

Different methods have been proposed, as for example the V-PCC compression standard (ISO/IEC 23090-5:2020: part 5: visual volumetric video-based coding (V3C) and video-based point cloud compression (V-PCC)). Such a standard for point cloud compression is based on projections of the points onto 2D planes so that video compression tools can be used for coding geometry and attributes of the points of the point cloud.

### SUMMARY

According to an aspect, a method for point cloud compression is provided. The method comprises coding one or more attributes of the point cloud using an invertible neural network. According to another aspect, an apparatus for point cloud compression is provided. The apparatus comprises one or more processors operable to code one or more attributes of a point cloud using an invertible neural network.

In an embodiment, the invertible neural network uses one or more sparse convolutions. In another embodiment, the invertible neural network is based on a normalizing flow. In some embodiments, the invertible neural network comprises at least one invertible block, the at least one invertible block comprising at least one voxel shuffling layer. In some variants, the voxel shuffling layer comprises arranging spatial location of voxels of a first region into channel location of a second region, a number of channels of an output of the voxel shuffling layer is higher than a number of channels of an input of the voxel shuffling layer, and a size of the output of the voxel shuffling layer is reduced with respect to the size of the input of the voxel shuffling layer, the voxel shuffling layer comprises filling at least one empty voxel in the second region.

In an embodiment, coding the one or more attributes of the point cloud comprises: obtaining a latent representation of the one or more attributes of the point cloud using at least the invertible neural network, encoding the latent in a bitstream using a neural network-based entropy encoder.

In an embodiment, coding the one or more attributes of the point cloud comprises: decoding a latent from a bitstream using a neural network-based entropy decoder, reconstructing the one or more attributes of the point cloud from the latent using at least the invertible neural network.

Further embodiments that can be used alone or in combination are described herein.

One or more embodiments also provide a computer program comprising instructions which when executed by one or more processors cause the one or more processors to perform the method according to any of the embodiments described herein. One or more of the present embodiments also provide a non-transitory computer readable medium and/or a computer readable storage medium having stored thereon instructions for coding one or more attributes of a point cloud according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates an example of a block diagram of a normalizing flow architecture for 2D image compression.

FIG. 3 illustrates an example of a squeeze layer in 2D with a number of channels C=1.

FIG. 4 illustrates an example of a squeeze layer in 3D with a number of channels C=1.

FIG. 5 illustrates an example of a squeeze layer in 3D with a number of channels C=1 and empty voxels in the input point cloud.

FIG. 6 illustrates an example of a block diagram of a method for encoding one or more attributes of the point cloud according to an embodiment.

FIG. 7 illustrates an example of a block diagram of a method for decoding one or more attributes of the point cloud according to an embodiment.

FIG. 8 illustrates an example of a normalizing flow architecture to compress an input point cloud, according to an embodiment.

FIG. 9A illustrates an example of a feature enhancement block used in the normalizing flow architecture illustrated on FIG. 8, according to an embodiment.

FIG. 9B illustrates an example of a sparse dense block used in the feature enhancement block in the normalizing flow architecture illustrated on FIG. 8, according to an embodiment.

FIG. 9C illustrates an example of a coupling layer used in the normalizing flow architecture illustrated on FIG. 8, according to an embodiment.

FIG. 9D illustrates an example of a transformation block for coupling layers used in the normalizing flow architecture illustrated on FIG. 8, according to an embodiment.

FIG. 10 illustrates an example of a squeeze layer in 3D for point cloud according to an embodiment,

FIG. 11 illustrates an example of a squeeze layer in 3D for point cloud according to another embodiment,

FIG. 12 illustrates an example of a squeeze layer in 3D for point cloud according to another embodiment,

FIG. 13 illustrates an example of a squeeze layer in 3D for point cloud according to another embodiment,

FIG. 14 illustrates an example of a part of a point cloud to be squeezed according to an embodiment.

FIG. 15 illustrates an example of convergence of the system according to an embodiment.

FIG. 16 illustrates examples of visual results of the system according to an embodiment.

FIG. 17 illustrates a block diagram of a system within which aspects of the present embodiments may be implemented, according to another embodiment.

FIG. 18 shows two remote devices communicating over a communication network in accordance with an example of the present principles.

FIG. 19 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

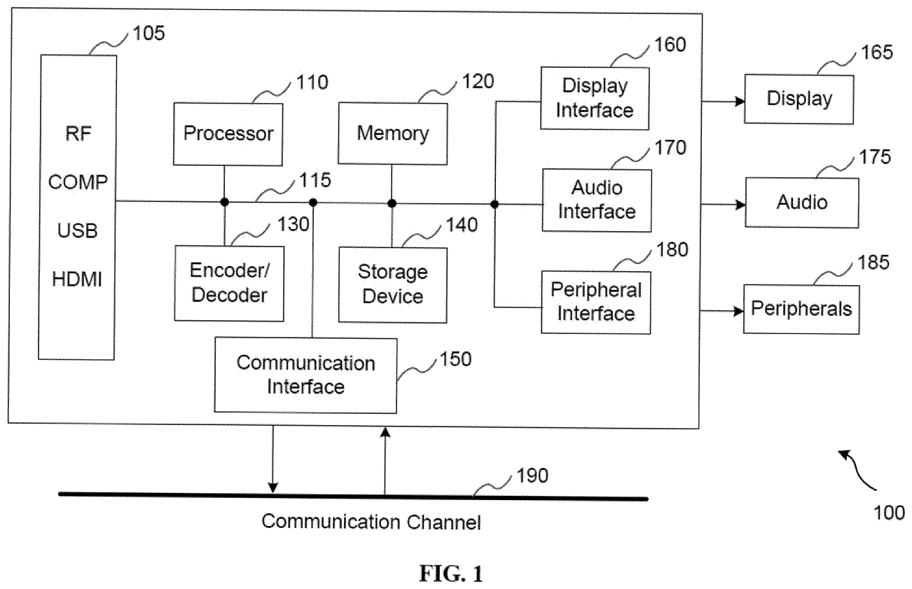

The aspects described and contemplated in this application can be implemented in many different forms. FIG. 1-18 below provide some embodiments, but other embodiments are contemplated and the discussion of FIGS. 1-18 does not limit the breadth of the implementations. At least one of the aspects generally relates to point cloud encoding and decoding, and at least one other aspect generally relates to transmitting a bitstream generated or encoded. These and other aspects can be implemented as a method, an apparatus, a computer readable storage medium having stored thereon instructions for encoding or decoding point cloud according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded point cloud or decoded point cloud, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input point cloud, the latent, the encoded latent, the decoded latent, the decoded point cloud or portions of the decoded point cloud, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television or a 3D display. In at least one embodiment, a fast external dynamic volatile memory such as a RAM is used as working memory for point cloud coding and decoding operations.

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device configured to display point clouds representation. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

Some of the embodiments described herein relate to point cloud compression, and more particularly to coding one or more attributes of a point cloud using a normalizing flow-based architecture. In some embodiments, the normalizing flow-based architecture is implemented using an invertible neural network.

Different methods for point cloud compression have been proposed, such as the projection-based compression methods in V-PCC, or learning based architectures such as in Wang et al.: J. Wang, Z. Ma, H. Wei, Y. Yu, V. Zakharchenko and D. Wang, [AI-3DGC] Point Cloud Attribute Compression using Sparse Tensor-Representation, Moving Pictures Expert Group, 2022.

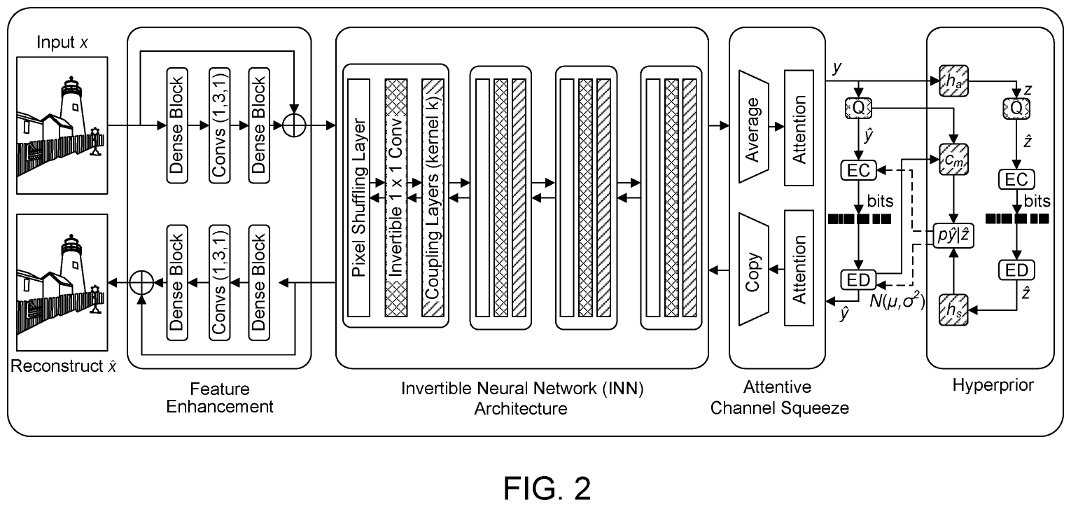

The use of normalizing flows as a compression architecture has been explored in the 2D image compression domain (Dihn et al.: L. Dihn, J. Sohl-Dickstein and S. Bengio, Density estimation using Real NVP, arXiv, 2016). However, this method utilizes a squeeze layer that is not adapted for point cloud data structure. Normalizing flows are a type of architecture that will take an input and produce a latent space from this input. An example of such an architecture for 2D compression is illustrated in FIG. 2, the figure is taken from Xie et al: Y. Xie, K. L. Cheng and Q. Chen, Enhanced Invertible Encoding for Learned Image Compression, arXiv, 2021.

Such an architecture is designed for 2D compression of dense 2D image field and is not suitable for sparse 3D data, such as point clouds data representation. Some embodiments described herein relate to point cloud coding using normalizing flow architecture adapted for sparse 3D data coding.

The latent space is a representation of the input with different coefficients. The goal is to produce a latent space that is easier to compress than the original input.

The normalizing flow architecture differs from other types of architecture in its property of inversibility. Meaning that once the latent space is produced, the original input can be reconstructed by applying the architecture in an inverted fashion. This property is very interesting considering that data compression can be naturally treated as an inversion problem. To be able to use such architectures in the 2D domain, a squeezing operation is performed, efficiently trading the spatial size of the input for channels in order for the operations to be performed. This block is implemented as a masking scheme for 2D images, as in Dihn et al., by taking 2×2×C blocks, where C is the number of channels and producing 1×1×4*C regions, dividing the spatial size by 4 and multiplying the number of channels by the same amount, as seen in FIG. 3. FIG. 3 shows a squeeze layer in 2D with a number of channels C=1, wherein 2D input data has a size of w×h is rearranged regions by regions to the output data having a size of w/2×h/2 and 4 channels.

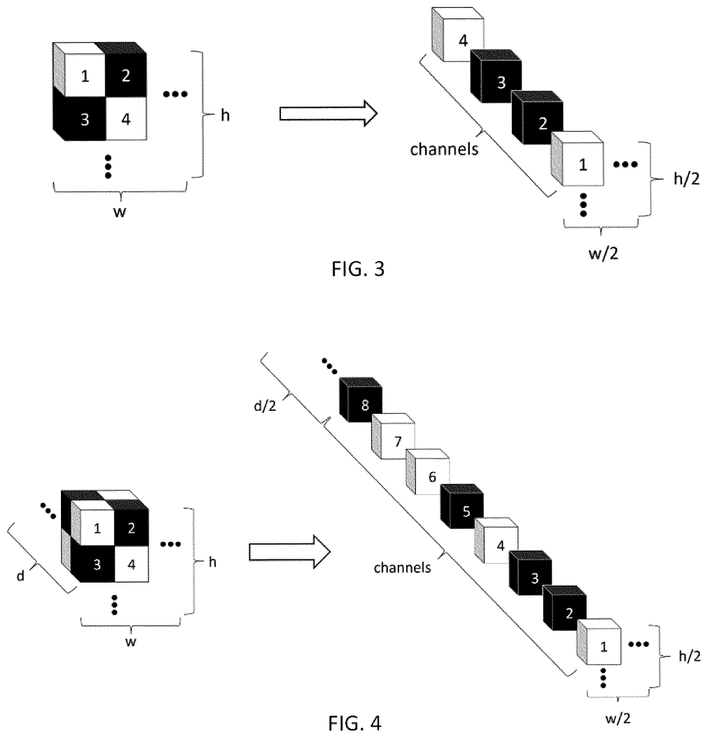

This block can be extended to the 3D space by adding one more dimension and increasing the number of produced channels, regions of 2×2×2×C will produce regions of 1×1×1×8*C, as seen in FIG. 4. FIG. 4 shows an example of a squeeze layer in 3D with a number of channels C=1, wherein 3D input data has a size of w×h×d is rearranged regions by regions to the output data having a size of w/2×h/2×d/2 and 8 channels, that is each element of the output of size w/2×h/2×d/2 has 8 channels.

However, for point clouds, which are a representation of sparse 3D data, i.e. where there are empty voxels, the above approach would not work properly. Point clouds can be represented using voxels according to which the 3D space is regularly divided into 3D units (voxels). Due to the sparse nature of the point cloud representation, the point cloud represented using voxels can comprise empty voxels. An empty voxel is a voxel which has no 3D point of the point cloud inside it. In other words, an empty voxel is a void voxel or is unoccupied while occupied voxels comprise point or points of the point cloud.

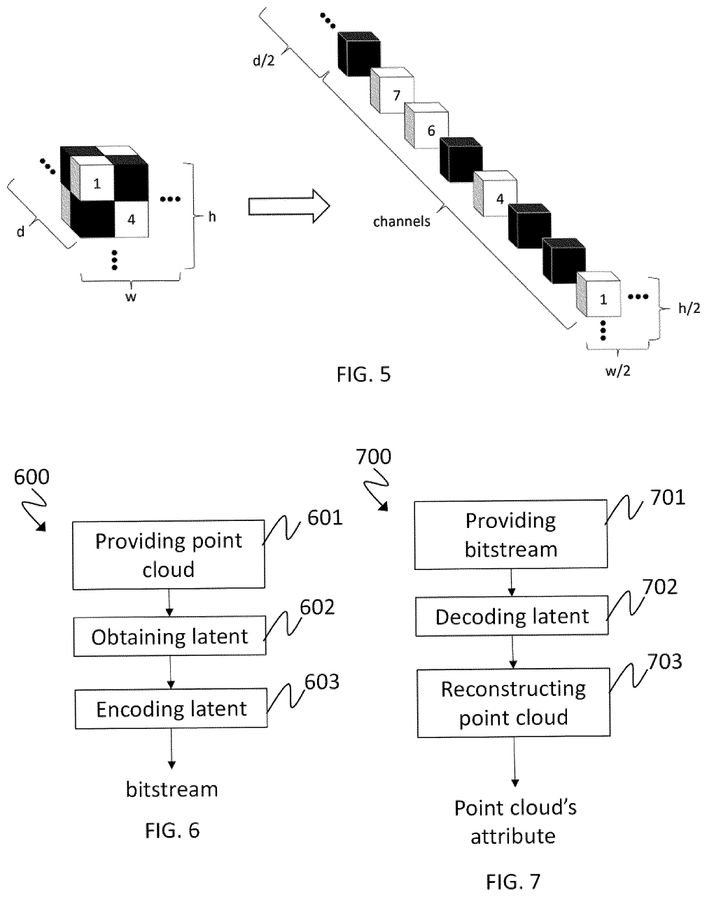

In FIG. 5, it is possible to observe that if we have empty voxels as in voxels numbered 2, 3, 5 and 8 (number are indicated in FIG. 4) shown in black with no number on FIG. 5, the squeezing operation would produce empty channels in the corresponding spatial location, which is not possible.

A solution could be to fill the empty voxels with zeros; however, this would cause the apparition of a large number of zeros in the resulting channels. The zeros would cause the learning process to suffer a big slowdown, since they do not contribute to the learning of the coefficients. Besides, this would stop the use of strategies that rely on calculating the average of the channels.

In the 2D domain, the squeeze layer re-arranges the input 2D data to allow the trade of spatial size by number of channels, without any information loss. For learning based approaches, this enables the use of more coefficients, making the network more robust without losing information.

The squeeze layer in the 3D domain would have the same objective, however, a naïve extension is not easily applied to point clouds because of the data structure. Since point clouds are sparse and do not have a regular grid support, the layer would produce many zeros that would not help the convergence of the algorithm and would produce poor results.

Some embodiments described herein tackle the squeeze layer and adapt it to the point cloud domain. The newly proposed layer uses some artificially filled points in the point cloud to replace the zeros and improve the convergence of the algorithm, as well as enabling the use of other tools that can improve the performance of the architecture. The embodiments described herein thus makes it possible to use normalizing flow architectures for learning based point cloud compression. Other embodiments described herein also propose extensions of the architecture presented in Xie et al. to handle the compression of point cloud color attributes.

According to an aspect, a method for coding one or more attributes of a point cloud using an invertible neural network.

An embodiment for coding one or more attributes of the point cloud using an invertible neural network is illustrated on FIG. 6. FIG. 6 illustrates an example of a block diagram of a method 600 for encoding one or more attributes of the point cloud. At 601, the point cloud is provided as input to the encoding system. The encoding system comprises at least an invertible neural network configured for encoding at least one attribute of the point cloud. In some variants, the encoding system comprises geometry encoding module configured for encoding geometry of the point cloud. At 602, a latent representation of at least one attribute of the point cloud is obtained using at least the invertible neural network. At 603, the latent is encoded to produce a bitstream, for instance using a neural network-based entropy encoder.

Another embodiment for coding one or more attributes of the point cloud using an invertible neural network is illustrated on FIG. 7. FIG. 7 illustrates an example of a block diagram of a method 700 for decoding one or more attributes of the point cloud. At 701, a bitstream is provided to the decoding system. The bitstream comprises at least coded data representative of at least one attribute of the point cloud. The decoding system comprises at least an invertible neural network configured for decoding at least one attribute of the point cloud. In some variants, the bitstream also comprises coded data representative of the geometry of the point cloud and the decoding system comprises geometry decoding module configured for decoding and reconstructing the geometry of the point cloud. At 702, a latent representation of at least one attribute of the point cloud is obtained by decoding the bitstream part representative of the at least one attribute, for instance using a neural network-based entropy decoder. At 703, the at least one attribute is reconstructed using at least the invertible neural network.

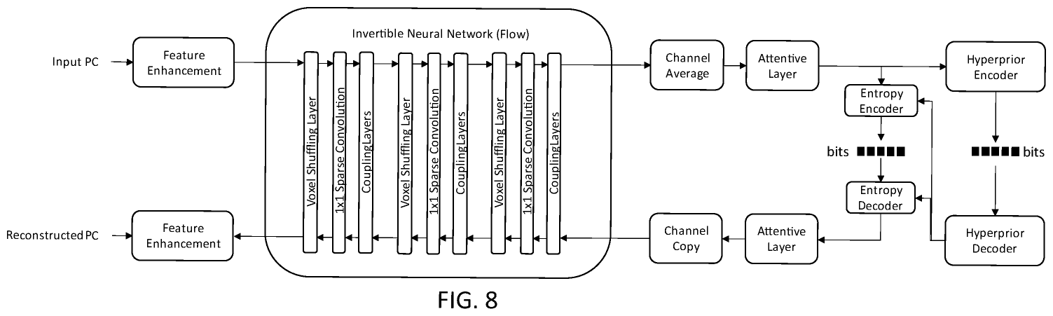

FIG. 8 illustrates an encoding and decoding system that can be used in the embodiments described above in relation with FIGS. 6 and 7. FIG. 8 illustrates a normalizing flow architecture adapted to the compression of 3D point cloud color attributes. The architecture contains a feature enhancement block, an invertible neural network (INN), a channel average block and an attentive layer. On the encoding side, the normalizing flow architecture produces a latent that is then encoded by an entropy encoder to produce a bitstream. In the example of FIG. 8, the entropy encoder is neural network-based encoder coupled with an hyperprior encoder. On the decoder side, the bitstream is entropy-decoded, using for instance a neural network-based entropy decoder coupled with an hyperprior decoder, to provide a decoded latent. The decoded latent is passed to the normalizing flow architecture comprising the attentive layer, a channel copy layer, the invertible neural network, and feature enhancement to produce the reconstructed point cloud.

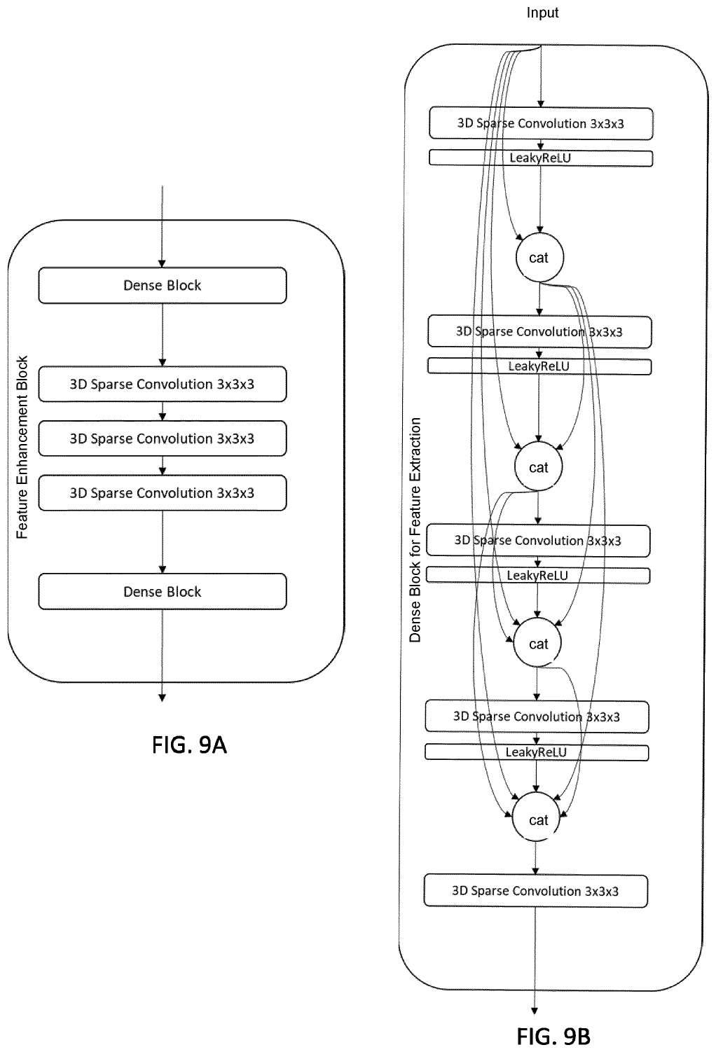

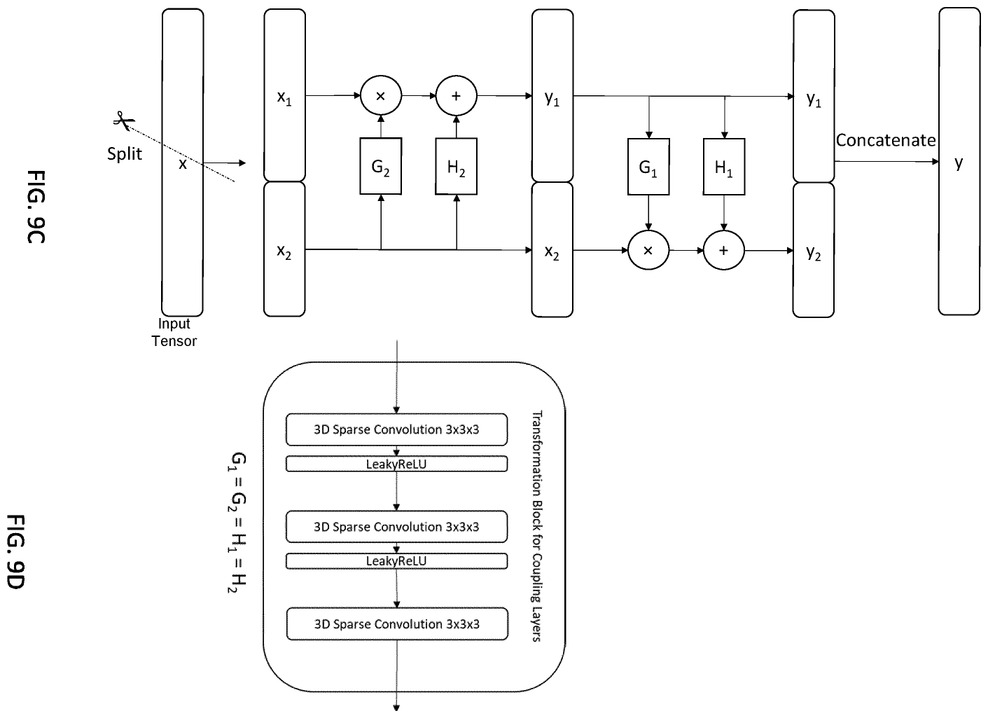

The feature enhancement layer has the goal to help extract more non-linear features from the original point cloud. An example of a feature enhancement layer is illustrated on FIG. 9A: it is composed of a dense block architecture followed by 3 3D Sparse Convolutions of kernel size 3×3×3 followed by another dense block architecture. An example of a sparse dense block that can be used in the feature enhancement layer is illustrated on FIG. 9B. The dense block has the goal of preserving initial features along the convolutions by concatenating (cat) the output of previous convolutions in the output of current convolution. This block has been proven to enhance performance of learning-based architecture. In the architecture illustrated on FIG. 8, the feature enhancement layer provides better features for the INN in the core of the illustrated network. The feature enhancement layer is inspired by the one from the architecture of Xie et al, but where sparse 3D convolutions are used instead of the 2D regular convolutions of Xie et al.

The invertible neural network is formed of 3 repetitions of the sequence: voxel shuffling layer, 1×1 convolution and coupling layers. Each of the layers has its own weight and bias, for that reason it is not represented as a loop. Since each time, data go through a voxel shuffling layer the number of channels changes, as will be explained later below the size of the filters in the subsequent convolutions also change. In the architecture of Xie et al, there is a sequence of 4 repetitions of the invertible block which comprises a pixel shuffling layer, a 1×1 convolution and 3 coupling layers.

In the architecture for point cloud illustrated in FIG. 8, the number of invertible blocks is reduced, this reduction is motivated by the evolution of the 2D architecture to the 3D domain. When adding a new dimension, without the reduced number of repetitions of the number of invertible blocks, the number of coefficients would explode, and the use of the network would be negatively affected. The number of coupling layers in the invertible block is also reduced for the same reason. For example, one squeeze operation comprises one 1×1 sparse convolution followed by 2 coupling layers.

For the INN to have the desired effect and the convergence to be sped up, the voxel shuffling layer is specifically designed, as will be explained later below, for sparse 3D data. The voxel shuffling layer has the goal of efficiently trading spatial dimension for channels without losing any information. The 1×1 convolution of the invertible block has the goal of enhancing feature representation for the coupling layers. In the INN illustrated on FIG. 8, the 1×1 convolution is a sparse 1×1 convolution, instead of the 1×1 convolution of Xie et al.

A coupling layer is a series of transformations that are applied to an input tensor and are completely inversible. The input tensor is split into 2 parts and each part goes through its own transformation according to a scheme illustrated on FIG. 9C. On FIG. 9C, the input tensor is split in 2 parts: x₁ and x₂ which are then transformed in y₁ and y₂ before being concatenated together again to provide an output y. The transformations G₁, G₂, H₁ and H₂ are all composed of 3 sparse 3D convolutions each. FIG. 9D illustrates an example of a transformation block for the coupling layers that can be used for the transformations G₁, G₂, H₁ and H₂. Inside a coupling layer, each one of the transformations is composed of 3 stages of 3D sparse convolutions of kernel 3×3×3 and a leakyReIU.

The arrangement of transformations guarantees the invertibility. In the embodiment illustrated on FIGS. 8 and 9C, all the convolutions used in the coupling layers are sparse 3D convolutions.

The channel average layer is a layer where the number of channels for the latent space is reduced by taking the average of all the channels in each spatial location. The voxel shuffling layer specifically designed for 3D sparse data (which is described further below) is especially important here, because without it, the channel average would have several zeros taken into account, passing distorted coefficients to the attentive layer.

The attentive layer has the goal of helping the architecture on focusing on more important areas in the point cloud. It uses a sigmoid function to give a weight to tell the encoder which regions of the point cloud would need more bits to be encoded. The attentive layer block illustrated on FIG. 8 is also modified by replacing all the regular 2D convolutions of Xie et al. by sparse 3D convolutions to be able to handle the sparsity and the extra dimension of the point clouds.

The sparse nature and high number of points of the point cloud representation are not adapted to the use of regular 3D convolutions. Therefore, the architecture illustrated on FIG. 8 uses sparse convolutions.

In another embodiment, a specifically designed 3D Voxel Shuffling layer is provided below, which allows the system illustrated on FIG. 8 to converge faster and for the channel average calculation to be properly executed, the voxel shuffling layer is described below.

### 3D Voxel Shuffling Layer

According to an aspect, a method is provided that allows to provide a 3D voxel shuffling layer wherein the empty voxels of the sparse 3D representation are filled during the squeeze operation. The sparse information, i.e. an indication of whether an input voxel is empty or not is provided to the 3D voxel shuffling layer by the geometry of the point cloud to which the 3D voxel shuffling layer has access. It is to be noted that the filling of the empty voxels during the squeezing operations has to be done at each invertible blocks of the invertible neural networks, as there can be regions wherein all voxels are empty in the regions, thus leading to rearranged voxels along channels that are also empty. These empty regions will be filled in subsequent stages of squeezing operations.

Also, it is to be noted that filling empty voxels in the 3D shuffling layer only needs to be performed at the encoder side. On the decoder side, there is no need to reconstruct the empty voxels whose locations are know thanks to the decoded geometry of the point cloud.

In a variant, the voxels are filled by calculating an average of all the filled (or non-empty) neighbors in the region to be squeezed and fill the empty voxels with the resulting average features, eliminating the zeros due to empty voxels, following the Algorithm 1 provided below:

### Algorithm 1.

SET averageFeatures to average of all filled voxels in squeeze region
FOR emptyVoxel in squeeze region
   SET emptyVoxel features as averageFeatures
END FOR
CALL squeezeLayer on squeeze region

By using this method, let's consider the example Point Cloud in FIG. 5 as a one channel point cloud where the index corresponds to the voxel features, an average value for the 2×2×2×C region is given by

$$\frac{1 + 4 + 6 + 7}{4} = 4.5 ,$$

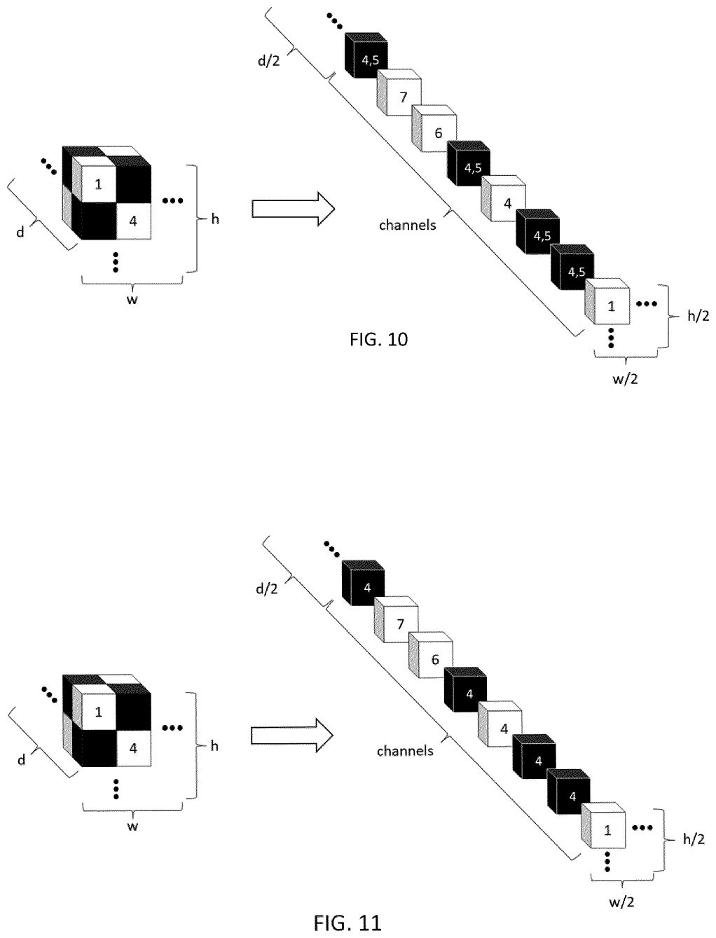

C being the number of channel and being C=1 in the example. The result after applying the 3D voxel shuffling layer in the variant presented herein is displayed in FIG. 10 showing the average method in a one channel point cloud, with empty voxels shown in black on the left side are filled with the average of the other voxels in the right side.

Another variant is to fetch the spatial nearest neighbor of an empty voxel and use it to fill the empty voxel. If there are several nearest neighbors having different features, an average of the features of the nearest neighbors is calculated and the nearest neighbor having a feature that is closest to the average is chosen to fill the empty voxel as illustrated by Algorithm 2 below:
FOR empty voxel in squeeze region
   CALL findNearestNeighbors with empty voxel
   CALL calculateAverageFeatures with nearestNeighbors
   CALL findBestNeighbor with averageFeatures and nearestNeighbors
   SET emptyVoxel features to bestNeighborFeatures
END FOR
CALL squeezeLayer on squeeze region

Taking as an example the point cloud in FIG. 5, the result of this variant is displayed in FIG. 11, nearest neighbors of empty voxel 2 are voxel with features 1, 4 and 6. The nearest neighbor that has a feature that is closest to the average is voxel 4.

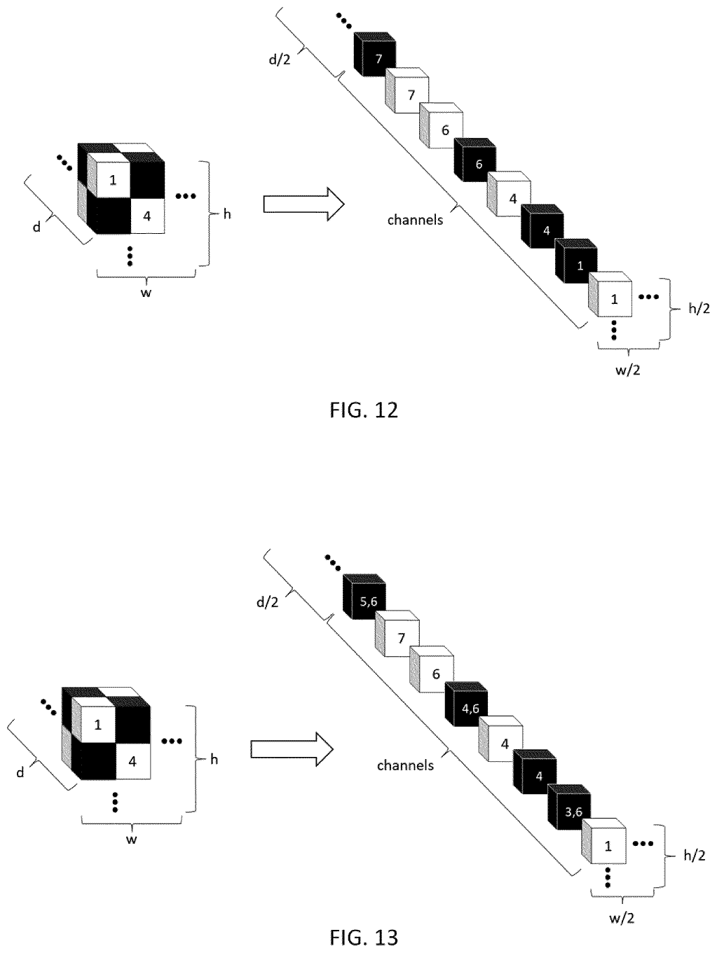

Alternatively, a priority order to select the nearest neighbor could be used as illustrated on FIG. 12 which shows the Nearest Neighbor method in a one channel point cloud, empty voxels in black on the left side, filled with the nearest neighbor following priority order (axis X, followed by axis Y, followed by axis Z).

In another variant, the average of the nearest neighbors instead of the average of the entire block can be used as illustrated on FIG. 13.

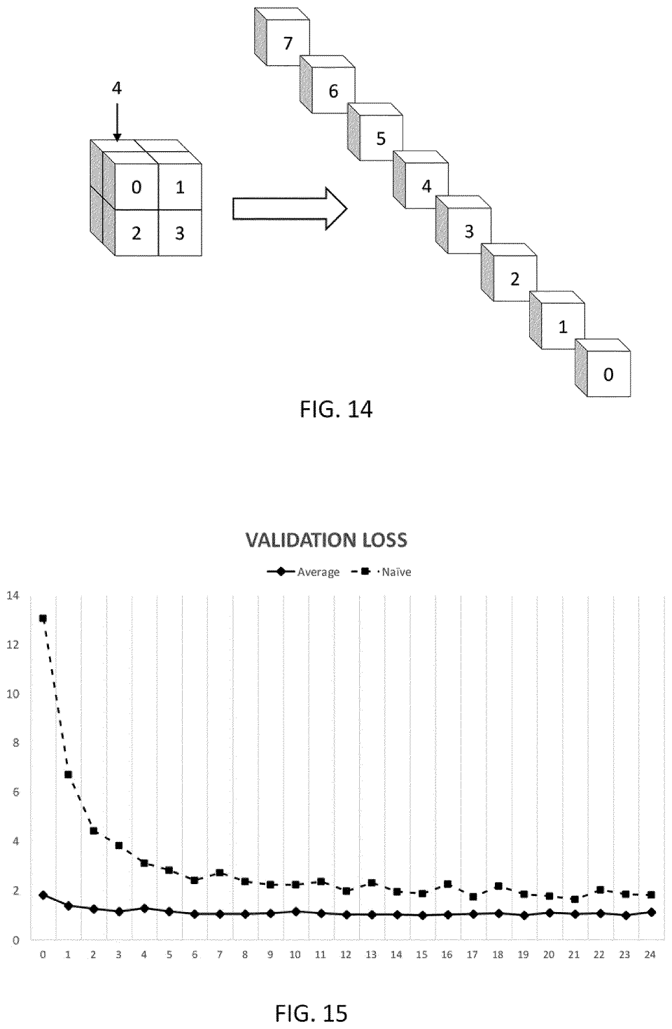

To better illustrate the process of the algorithm in a point cloud that contains 3 color channels, an example of a point cloud is considered that has only 3 filled voxels, indexed by 0, 1 and 4 (the voxel right next to voxel 0 in the z axis), each one with 3 color channels R,G,B, that is supposed to be squeezed, as showed in FIG. 14.

The values for RGB in each of the voxels is given by Table 1.

TABLE 1
RGB Values for the example Point Cloud

| | Idx | | | | | | | |
|---|---|---|---|---|---|---|---|---|
| Channels | 0 | 1 | 2 | 3 | 4 | 5 | 6 | 7 |
| R | 128 | 100 | — | — | 192 | — | — | — |
| G | 96 | 100 | — | — | 128 | — | — | — |
| B | 64 | 100 | — | — | 64 | — | — | — |

The resulting operation of the 3D voxel shuffling layer produces one spatial location, with 24 channels, the concatenation of the 3 channels of all the 8 voxels in the squeeze region. In the average mode, the mode in Error! Reference source not found., the 3 filled voxels are considered and the average for each one of the color channels is calculated. The empty channels are filled by those results, following the same order as it was if the voxels were filled.

$${R}_{mean} = \frac{128 + 100 + 192}{3} = 140 ;$$

$${G}_{mean} = \frac{96 + 100 + 128}{3} = 108 ;$$

$${B}_{mean} = \frac{64 + 100 + 64}{3} = 76 ;$$

The second variant uses the nearest neighbor to fill the empty voxels. The nearest neighbors are displayed in Table 2. As shown, the voxels 5 and 7 have 2 neighbors that are at the same distance. The chosen neighbor to fill those voxels can be done in two diverse ways. The chosen voxel could follow a priority order, e.g., x axis, y axis and z axis, meaning that the chosen neighbor for voxels 5 and 7 would be voxel 4.

The second way is to choose the neighbor that is closer to the average of the region. In the example, by calculating the D1 distance of the different filled voxels, it can be seen that voxel 1 has a distance of |100−140|+|100−108|+|100−76|=72, as voxel 4 has a distance of |192−140|+|128−108|+|64−76|=84. Meaning voxel 1 would be chosen to fill the empty voxels.

TABLE 2
Nearest Neighbors Indexes

| Empty Voxel Index | 2 | 3 | 5 | 6 | 7 |
|---|---|---|---|---|---|
| Nearest Neighbor Index | 0 | 1 | 1, 4 | 4 | 1, 4 |

The resulting 24 channels for each variant of the algorithm can be seen in Table 3.

TABLE 3
Results after squeeze operation

| Channels\ | | Average | Nearest Neighbor - | Nearest Neighbor - |
|---|---|---|---|---|
| Method | Naive | Mode | Average Mode | Priority List Mode |
| 0-R | 128 | 128 | 128 | 128 |
| 0-G | 64 | 64 | 64 | 64 |
| 0-B | 32 | 32 | 32 | 32 |
| 1-R | 100 | 100 | 100 | 100 |
| 1-G | 100 | 100 | 100 | 100 |
| 1-B | 100 | 100 | 100 | 100 |
| 2-R | 0 | 140 | 128 | 128 |
| 2-G | 0 | 108 | 64 | 64 |
| 2-B | 0 | 76 | 32 | 32 |
| 3-R | 0 | 140 | 100 | 100 |
| 3-G | 0 | 108 | 100 | 100 |
| 3-B | 0 | 76 | 100 | 100 |
| 4-R | 192 | 192 | 192 | 192 |
| 4-G | 128 | 128 | 128 | 128 |
| 4-B | 64 | 64 | 64 | 64 |
| 5-R | 0 | 140 | 192 | 100 |
| 5-G | 0 | 108 | 128 | 100 |
| 5-B | 0 | 76 | 64 | 100 |
| 6-R | 0 | 140 | 192 | 192 |
| 6-G | 0 | 108 | 128 | 128 |
| 6-B | 0 | 76 | 64 | 64 |
| 7-R | 0 | 140 | 192 | 100 |
| 7-G | 0 | 108 | 128 | 100 |
| 7-B | 0 | 76 | 64 | 100 |

The embodiments presented above are not limited to the 3D case and can be used also for the 2D domain and also for higher dimensions. The embodiments can be applied to any type of sparse data for which it is desired to trade the spatial size for the number of channels.

The 3D voxel shuffling layer presented above in any one of the embodiments or variants allow to avoid the use of zeros in the convolutions for learning based algorithms, speeds-up training convergence, and avoid vanishing coefficients. The embodiments above make it possible to apply channel-wise average calculations, allow the use of channel squeezing layers, meaningfully calculate the average of the channels in a determined block, and it also allows the use of architectures of the type normalizing flow on point clouds, by adapting the pixel shuffling layer to the sparse 3D domain.

### Results

Some results of the system presented above are presented below. Two networks are trained with the exact same architecture, structure, data and test conditions to verify the difference between the naïve approach (extending the voxel shuffling for the 3D sparse domain by zero filling) and the embodiments presented above (the sparse voxel shuffling block using the average method detailed by Error! Reference source not found. and FIG. 10).

It can be observed that the proposed embodiment speeds up the convergence (it takes fewer epochs of training for the loss to significantly drop) as displayed in FIG. 15 showing the validation loss for 20 epochs. Also, the convergence happens at a lower value than the one presented in the naïve approach.

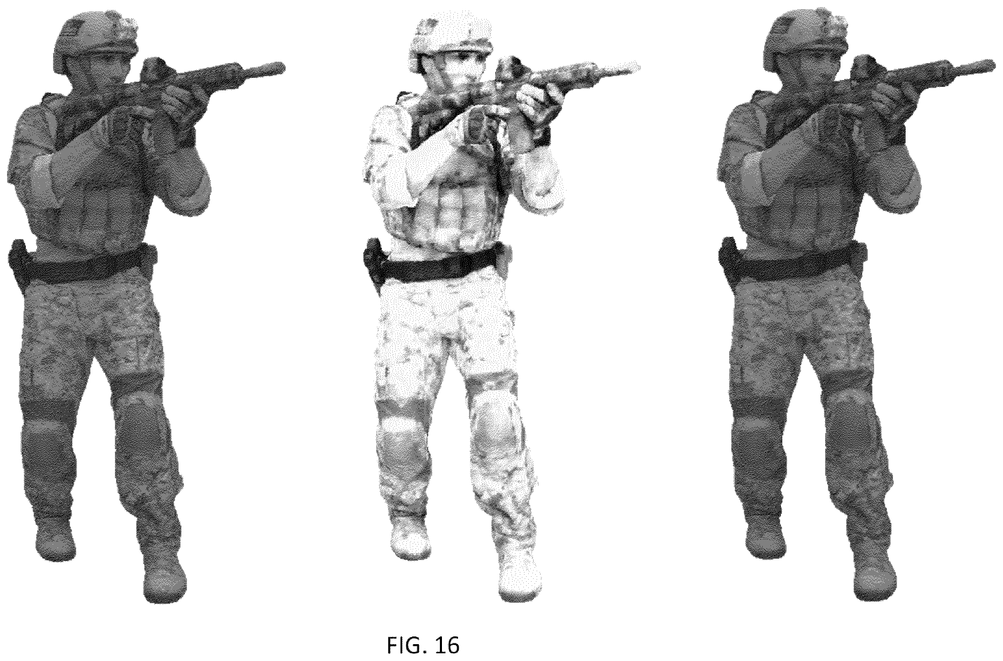

Other than that, it can also be observed a gain in the test results with the two different trained architectures. Using the naïve approach, a very low PSNR can be obtained and the reconstructed point cloud tends to have distorted colors, while, by using the proposed embodiment, the network is properly trained to obtain a good reconstruction with a better quality, as can be seen in FIG. 16. FIG. 16 shows some visual results with on the left the original Point Cloud—Soldier_vox10_690; on the center the result by applying the naïve approach: the network over saturate the colors to compensate for the large number of zeros; on the right is shown the proposed embodiment in the variant defined by Algorithm 1. Without the proposed embodiments presented above, the network tries to compensate for all the zeros in the vectors by saturating the other channels. The quantitative result of the comparison is in Table 4. As can be seen, the proposed embodiment obtains much better PSNR results with fewer bits per occupied voxel.

TABLE 4
Quantitative result comparison of the embodiment
described herein and the naive approach under
the same training and testing conditions

| | Naïve Approach | Algorithm 1 embodiment |
|---|---|---|
| Y-PSNR (dB) | 9.9 | 33.5 |
| Bits per voxel | 0.72 | 0.32 |

### Signaling/Syntax

Current activities in MPEG AI-PCC works on defining some AI models for compression and decompression of Point Clouds geometry and photometry. The MPEG group currently handle photometry separately from the geometry. Embodiments provided herein permit to use a Normalizing Flow architecture instead of a Variational Auto-Encoder as in Wang et al to perform the coding/decoding of the Photometry. Both solutions could co-exist in the codec. Therefore, a signaling flag indicating which deep decoder architecture to use is added in the bitstream. An example of such signaling is illustrated with Table 5 below:

TABLE 5
Signaling the use of the VAE or Normalizing
Flow in Point Cloud Learning Based bitstream

| | | |
|---|---|---|
| PHOTOMETRY_CODEC_{—} | 0 −> use Variational Auto- | 1 bit flag |
| ARCHITECTURE | Encoder | |
| | 1 −> use Normalizing flow | |

Any one of the embodiments presented above can be integrated in a point cloud coding standard for coding the attributes of the point cloud, such as for example the G-PCC coding standard extension based on Deep Learning.

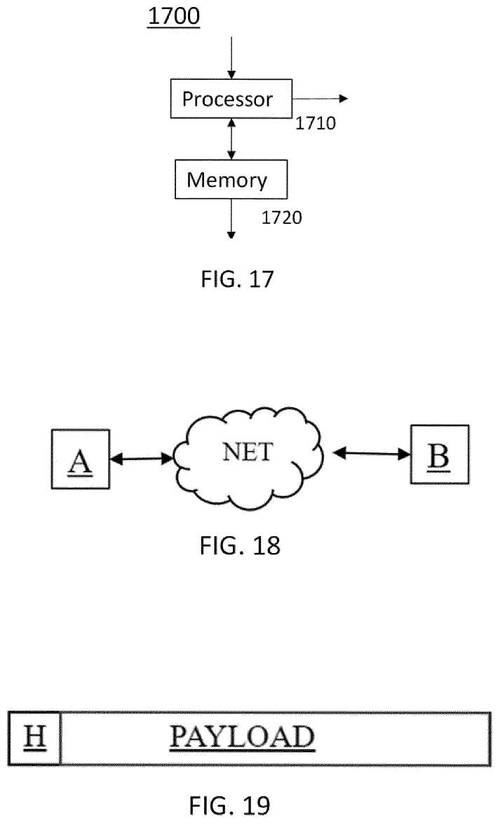

FIG. 17 illustrates a block diagram of a system within which aspects of the present embodiments may be implemented, according to another embodiment. FIG. 17 shows one embodiment of an apparatus 1700 for encoding or decoding a point cloud or attributes of a point cloud as described according to any one of the embodiments described herein. The apparatus comprises Processor 1710 and can be interconnected to a memory 1720 through at least one port. Both Processor 1710 and memory 1720 can also have one or more additional interconnections to external connections.

Processor 1720 is also configured to code one or more attributes of a point cloud using an invertible neural network, using any one of the embodiments described herein. For instance, the processor 1710 is configured using a computer program product comprising code instructions that implements any one of embodiments described herein.

In an embodiment, illustrated in FIG. 18, in a transmission context between two remote devices A and B over a communication network NET, the device A comprises a processor in relation with memory RAM and ROM which are configured to implement a method for encoding a point cloud, as described with FIG. 1-16 and the device B comprises a processor in relation with memory RAM and ROM which are configured to implement a method for decoding a point cloud as described in relation with FIGS. 1-16. In accordance with an example, the network is a broadcast network, adapted to broadcast/transmit encoded point cloud from device A to decoding devices including the device B.

FIG. 19 shows an example of the syntax of a signal transmitted over a packet-based transmission protocol. Each transmitted packet P comprises a header H and a payload PAYLOAD. In some embodiments, the payload PAYLOAD may comprise coded point cloud data according to any one of the embodiments described above. In a variant, the signal comprises a flag indicating a deep learning method for decoding the point cloud or for decoding one or more attributes of the point cloud.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art. Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method comprising:
providing one or more attributes of a point cloud to an input of an invertible neural network, the invertible neural network comprising at least one invertible block that includes at least one coupling layer, at least one 1×1 sparse convolution layer and at least one voxel shuffling layer,
arranging spatial location of voxels of the point cloud into channel locations by the at least one voxel shuffling layer of the invertible neural network,
performing a 1×1 sparse convolution on an output of the at least one voxel shuffling layer by the at least one 1×1 sparse convolution layer,
performing 3D sparse convolutions on an output of the at least one 1×1 sparse convolution layer by the at least one coupling layer, and
obtaining coded data representative of the one or more attributes of the point cloud from an output of the invertible neural network.

2. A method comprising:
providing coded data representative of one or more attributes of a point cloud to an input of an invertible neural network, the invertible neural network comprising at least one invertible block that includes at least one coupling layer, at least one 1×1 sparse convolution layer and at least one voxel shuffling layer,
performing 3D sparse convolutions on the coded data by the at least one coupling layer,
performing a 1×1 sparse convolution on an output of the at least one coupling layer by the at least one 1×1 sparse convolution layer,
arranging channel locations of an output of the at least one 1×1 sparse convolution layer into spatial locations of the point cloud by the at least one voxel shuffling layer, and
obtaining the one or more attributes of the point cloud from an output of the invertible neural network.

3. The method of claim 1, wherein
at least one empty voxel of a spatial location is filled with a given value when arranged at a channel location by the at least one voxel shuffling layer.

4. An apparatus, comprising one or more processors, wherein said one or more processors is operable to:
provide one or more attributes of a point cloud to an input of an invertible neural network,
implement the invertible neural network comprising at least one invertible block that includes at least one voxel shuffling layer that arranges spatial location of voxels of the point cloud into channel locations, at least one 1×1 sparse convolution layer that performs a 1×1 sparse convolution on an output of at least one voxel shuffling layer, and at least one coupling layer that performs 3D sparse convolutions on an output of at least one 1×1 sparse convolution layer, and
obtain coded data representative of the one or more attributes of the point cloud from an output of the invertible neural network.

5. An apparatus, comprising one or more processors, wherein said one or more processors is operable to:
provide coded data representative of one or more attributes of a point cloud to an input of an invertible neural network,
implement the invertible neural network comprising at least one invertible block that includes at least one coupling layer that performs 3D sparse convolutions on the coded data, at least one 1×1 sparse convolution layer that performs a 1×1 sparse convolution on an output of the at least one coupling layer and at least one voxel shuffling layer that arranges channel locations of an output of the at least one 1×1 sparse convolution layer into spatial location of voxels of the point cloud, and
obtain the one or more attributes of the point cloud from an output of the invertible neural network.

6. (canceled)

7. The method of claim 2, wherein the invertible neural network is based on a normalizing flow.

8. (canceled)

9. The method of claim 1, wherein a number of channels of an output of the at least one voxel shuffling layer is higher than a number of channels of an input of the at least one voxel shuffling layer, and wherein a size of the output of the at least one voxel shuffling layer is reduced with respect to a size of the input of the at least one voxel shuffling layer.

10. The method of claim 3, wherein the given value is an average of all non-empty voxels in a first region or an average of all nearest neighbors to the at least one empty voxel.

11. The method of claim 3, wherein the given value is a value of a nearest neighbor of the at least one empty voxel.

12. The method of claim 11, wherein in case of more than one nearest neighbor to the at least one empty voxel, the given value is a value of the nearest neighbor that is closest to an average of all nearest neighbors to the at least one empty voxel.

13. The method of claim 11, wherein in case of more than one nearest neighbor to the at least one empty voxel, the given value is a value of a nearest neighbor along a given axis, the given axis being determined according to a priority order.

14-16. (canceled)

17. The method of claim 1, wherein obtaining coded data representative of the one or more attributes of the point cloud comprises:
obtaining a latent representative of the one or more attributes of the point cloud using at least the invertible neural network,
encoding the latent in a bitstream using a neural network-based entropy encoder.

18. The method of claim 2, wherein obtaining the one or more attributes of the point cloud further comprises:
decoding a latent from a bitstream using a neural network-based entropy decoder.
reconstructing the one or more attributes of the point cloud from the latent using at least the invertible neural network.

19. (canceled)

20. A non-transitory computer readable medium storing executable program instructions to cause a computer executing the instructions to perform a method according to claim 2.

21-22. (canceled)

23. The apparatus of claim 5, comprising:
at least one of (i) an antenna configured to receive a signal, the signal including data representative of a point cloud, (ii) a band limiter configured to limit the signal to a band of frequencies that includes the data representative of the point cloud, or (iii) a display configured to display the point cloud.

24. (canceled)

25. The apparatus of claim 5, wherein the invertible neural network comprises 3 invertible blocks.

26. The apparatus of claim 5, wherein the at least one invertible block comprises 2 coupling layers.

27. The apparatus of claim 4, wherein the invertible neural network comprises 3 invertible blocks.

28. The apparatus of claim 4, wherein the at least one invertible block comprises 2 coupling layers.

29. The method of claim 1, wherein the invertible neural network is based on a normalizing flow.
